(19) United States
(12) Patent Application Publication
(10) Pub. No.: US 2026/0179561 A1
(43) Pub. Date: Jun. 25, 2026

(54) PIXEL CIRCUIT AND DRIVING METHOD THEREOF, DISPLAY PANEL AND DISPLAY APPARATUS

(71) Applicant: Everdisplay Optronics (Shanghai) Co., Ltd., Shanghai (CN)

(72) Inventors: Qi WANG, Shanghai (CN); Fan HU, Shanghai (CN); Jie LIU, Shanghai (CN); Han ZHANG, Shanghai (CN); Ying-Hsiang TSENG, Shanghai (CN); Lina XIAO, Shanghai (CN)

(73) Assignee: Everdisplay Optronics (Shanghai) Co., Ltd., Shanghai (CN)

(21) Appl. No.: 18/856,640

(22) PCT Filed: Jun. 20, 2024
(86) PCT No.: PCT/CN2024/100341

§ 371 Date: Oct. 14, 2024

(30) Foreign Application Priority Data
Jun. 21, 2023 (CN) 202310748083.1
Nov. 1, 2023 (CN) 202311448053.5

(51) Int. Cl. G09G 3/3241

(52) U.S. Cl. CPC G09G 3/3241; G09G 2300/043; G09G 2300/0819; G09G 2310/08; G09G 2320/0233; G09G 2320/0247

(57) ABSTRACT

Disclosed are a pixel circuit and a driving method thereof, a display panel and a display apparatus. The pixel circuit includes an initialization unit, a data writing unit, a driving transistor, a threshold compensation unit and a storage capacitor; the initialization unit transmits an initialization voltage to a first node to charge the storage capacitor; the first node is a connection node among a second terminal of the storage capacitor, a control terminal of the driving transistor, and the threshold compensation unit; the threshold compensation unit and the data writing unit obtain a threshold voltage of the driving transistor and a data voltage transmitted by a data line, and write the threshold voltage and the data voltage to the first node; and a coupling unit is electrically connected to at least one of the initialization unit, the threshold compensation unit or the driving transistor.

### CROSS-REFERENCE TO RELATED APPLICATION

The present disclosure is a US national phase of International Application No. PCT/CN2024/100341, filed on Jun. 20, 2024, which is based upon and claims priority to Chinese Patent Application No. 202310748083.1, filed on Jun. 21, 2023, and Chinese Patent Application No. 202311448053.5, filed on Nov. 1, 2023, and the entire content of which is incorporated herein by reference.

### TECHNICAL FIELD

The present disclosure relates to the technical field of display, and particularly, to a pixel circuit and a driving method thereof, a display panel and a display apparatus.

### BACKGROUND

Organic Light Emitting Display (OLED) has many advantages such as full solid state, self-luminescence, wide viewing angle, wide color gamut, fast response speed, high luminous efficiency, high brightness, high contrast, ultra-thin, ultra-light, low power consumption, wide operating temperature range, ability to produce large-size and flexible panels and simple manufacturing process, which can realize truly flexible display and has attracted increasing attention and recognition in the market in recent years.

OLEDs use different refresh rates for display in different application scenarios. For example, a driving manner with higher refresh rate is used to drive the display of dynamic images to ensure the smoothness of the displayed images; and a driving manner with lower refresh rate is used to drive the display of static images to reduce power consumption. When displaying at a low refresh rate, flickering will occur, which affects the visual experience.

### SUMMARY

In view of the problems in the related art, the purpose of the present disclosure is to provide a pixel circuit and a driving method thereof, a display panel and a display apparatus, to solve the problem of obvious flickering when the screen displays at a low refresh rate.

An embodiment of the present disclosure provides a pixel circuit, including: an initialization unit, a data writing unit, a driving transistor, a threshold compensation unit and a storage capacitor; where
the initialization unit is configured to transmit an initialization voltage to a first node in response to a first scan signal, to charge the storage capacitor; the first node is a connection node among a second terminal of the storage capacitor, a control terminal of the driving transistor, and the threshold compensation unit;
the threshold compensation unit and the data writing unit are configured to obtain a threshold voltage of the driving transistor and a data voltage transmitted by a data line in response to a second scan signal, and to write the threshold voltage and the data voltage to the first node; and
a coupling unit is electrically connected to at least one of the initialization unit, the threshold compensation unit or the driving transistor to reduce a potential fluctuation of the first node during a light emitting stage.

In some embodiments, the initialization unit includes a first transistor, a control terminal of the first transistor is electrically connected to a first scan line, a first terminal of the first transistor is electrically connected to a first initialization signal line, and a second terminal of the first transistor is electrically connected to the first node.

In some embodiments, the first transistor is a dual-gate transistor, the coupling unit includes a first capacitor, a first terminal of the first capacitor is electrically connected to the first scan line, and a second terminal of the first capacitor is electrically connected to an intermediate node between the first terminal and the second terminal of the first transistor.

In some embodiments, the threshold compensation unit includes a second transistor, a control terminal of the second transistor is electrically connected to a second scan line, a first terminal of the second transistor is electrically connected to the first node, and a second terminal of the second transistor is electrically connected to the driving transistor.

In some embodiments, the second transistor is a dual-gate transistor, the pixel circuit further includes a first power supply, the coupling unit includes a second capacitor, a first terminal of the second capacitor is electrically connected to the first power supply, and a second terminal of the second capacitor is electrically connected to an intermediate node between the first terminal and the second terminal of the second transistor.

In some embodiments, the data writing unit includes a third transistor, a control terminal of the third transistor is electrically connected to the second scan line, a first terminal of the third transistor is electrically connected to the data line, and a second terminal of the third transistor is electrically connected to the driving transistor.

In some embodiments, the pixel circuit further includes a reset unit and a light emitting control unit, where the reset unit is configured to reset a potential of a first terminal of a light emitting device in response to a third scan signal; and the light emitting control unit is configured to output a driving current output by the driving transistor to the light emitting device in response to a light emitting control signal, so that the light emitting device emits light.

In some embodiments, the reset unit includes a fourth transistor, a control terminal of the fourth transistor is electrically connected to a third scan line, a first terminal of the fourth transistor is electrically connected to a second initialization signal line, and a second terminal of the fourth transistor is electrically connected to the first terminal of the light emitting device.

In some embodiments, the pixel circuit further includes a second power supply, where the light emitting control unit is provided between the first power supply and the second power supply to drive the light emitting device to emit light.

In some embodiments, the light emitting control unit includes a fifth transistor and a sixth transistor, where a control terminal of the fifth transistor is electrically connected to a light emitting control line; a first terminal of the fifth transistor is electrically connected to the first power supply, and the second terminal of the fifth transistor is electrically connected to the driving transistor; and
a control terminal of the sixth transistor is electrically connected to the light emitting control line, a first terminal of the sixth transistor is electrically connected to the driving transistor, and a second terminal of the sixth transistor is electrically connected to the first terminal of the light emitting device.

In some embodiments, the coupling unit further includes an eighth transistor, a control terminal of the eighth transistor is electrically connected to the third scan line or a fourth scan line, a first terminal of the eighth transistor is electrically connected to a third initialization signal line, and a second terminal of the eighth transistor is electrically connected to the driving transistor.

In some embodiments, a first terminal of the driving transistor is electrically connected to the second terminal of the fifth transistor, and a second terminal of the driving transistor is electrically connected to the first terminal of the sixth transistor and the second terminal of the second transistor.

In some embodiments, the driving transistor includes a first sub-driving transistor and a second sub-driving transistor, a control terminal of the first sub-driving transistor and a control terminal of the second sub-driving transistor are electrically connected to the first node, a first terminal of the first sub-driving transistor is electrically connected to the second terminal of the fifth transistor, and a second terminal of the first sub-driving transistor is electrically connected to the first terminal of the sixth transistor;
a first terminal of the second sub-driving transistor is electrically connected to the second terminal of the third transistor and the second terminal of the fifth transistor, and a second terminal of the second sub-driving transistor is electrically connected to the first terminal of the second transistor.

An embodiment of the present disclosure further provides a method for driving a pixel circuit, used for driving the pixel circuit as described above, and the method includes following steps.

In an initialization stage, the first scan signal is at a working level, and a first initialization voltage initializes a potential of the first node.

In a data writing stage and a threshold compensation stage, the second scan signal is at a working level, and the data voltage and the threshold voltage of the driving transistor are transmitted to the first node and stored in the storage capacitor.

In a light emitting stage, a light emitting control signal is at a working level, and a driving current is provided to a light emitting device via the pixel circuit, to control a light emitting display of the light emitting device.

The potential fluctuation of the first node in the light emitting stage is reduced by the coupling unit.

An embodiment of the present disclosure further provides a display panel, which includes the pixel circuit as described above.

The pixel circuit and driving method thereof, display panel and display apparatus provided by the present disclosure have the following advantages:

The potential fluctuation of the first node during the light emitting stage is reduced by the coupling unit. When the potential fluctuation of the first node is reduced, the brightness fluctuation is reduced, thereby improving the obvious flicker problem that occurs when the screen displays at a low refresh rate.

### BRIEF DESCRIPTION OF THE DRAWINGS

Other features, objects and advantages of the present disclosure will become more apparent by reading the detailed description of non-limiting embodiments with reference to the following accompanying drawings.

FIG. 1 is a schematic diagram of brightness changes of two adjacent frames when the refresh rate is 60 Hz in the prior art;

FIG. 2 is a schematic diagram of brightness changes of two adjacent frames when the refresh rate is 30 Hz in the prior art;

FIG. 3 is a schematic diagram of a pixel circuit of a first embodiment of the present disclosure;

FIG. 4 is a driving timing sequence diagram corresponding to the pixel circuit of the first embodiment of the present disclosure;

FIG. 5 is a diagram illustrating a potential change of a node N1 under the driving timing sequence corresponding to FIG. 4;

FIG. 6 is a diagram illustrating a potential of an intermediate node T1m under different capacitance values of Cm1 in the first embodiment of the present disclosure;

FIG. 7 is a schematic diagram of a pixel circuit of a second embodiment of the present disclosure;

FIG. 8 is a driving timing sequence diagram corresponding to the pixel circuit of the second embodiment of the present disclosure;

FIG. 9 is a diagram illustrating potential changes of a node N1 and a node T2m when a first capacitor Cm1 exists or not in the second embodiment under the driving timing sequence of FIG. 7.

FIG. 10 is a diagram illustrating a potential change of the node N1 under different capacitance values of a second capacitor Cm2 in the second embodiment of the present disclosure;

FIG. 11 is a diagram illustrating a potential change of an intermediate node T2m under different capacitance values of the second capacitor Cm2 in the second embodiment of the present disclosure;

FIG. 12 is a schematic diagram of a pixel circuit of a third embodiment of the present disclosure;

FIG. 13 is a driving timing sequence diagram of the pixel circuit of the third embodiment of the present disclosure;

FIG. 14 is a schematic diagram of a pixel circuit of a fourth embodiment of the present disclosure;

FIG. 15 is a schematic diagram of a pixel circuit of a fifth embodiment of the present disclosure.

### DETAILED DESCRIPTION

Example implementations will now be described more fully with reference to the accompanying drawings. However, the example implementations can be embodied in various forms and should not be construed as being limited to the implementations set forth herein. Rather, these implementations are provided so that the present disclosure will be thorough and complete, and will fully convey the concepts of the example implementations to those skilled in the art. In the accompanying drawings, the same reference signs denote the same or similar structures, and therefore repeated descriptions thereof will be omitted. The words “or” or “either” in the specification may mean “and” or “or”.

In the representation of the present application, the representation with references to the terms “one embodiment”, “some embodiments”, “example”, “specific example” or “some examples” mean that the specific features, structures, materials or characteristics represented in combination with this embodiment or example are included in at least one embodiment or example of the present specification. Moreover, the specific features, structures, materials or characteristics represented may be combined in any one or more embodiments or examples in a suitable manner. In addition, those skilled in the art may combine and integrate different embodiments or examples and features of different embodiments or examples represented in the specification under the condition of not contradicting each other.

In addition, the terms “first” and “second” are used for indicative purposes only and should not be understood as indicating or implying relative importance or implicitly specifying the quantity of technical features indicated. Therefore, a feature defined with “first” or “second” may explicitly or implicitly include at least one of such features. In the representation of the present application, the term “a plurality of” means two or more, unless otherwise expressly and specifically limited.

The transistors used in the embodiments of the present disclosure may be thin film transistors. The transistors may be divided into N-type and P-type according to the characteristics of the thin film transistors, and the following embodiments are described using P-type transistors. In the embodiments of the present disclosure, the control terminal refers to a gate, the first terminal refers to a source, and the second terminal refers to a drain. When a low level is input to the gate of the P-type transistor, the source and the drain are conducted. It should be noted here that, the embodiments of the present disclosure takes an example in which all transistors are P-type transistors, then the working level refers to an effective level at which the P-type transistor is turned on, i.e., a low level, and the non-working level refers to a high level.

The light emitting device in the embodiments of the present disclosure includes, but is not limited to, an organic light emitting diode (OLED). The light emitting device below is described by taking OLED as an example. In the embodiments of the present disclosure, a first terminal of OLED refers to the anode of OLED, and a second terminal of OLED refers to the cathode of OLED.

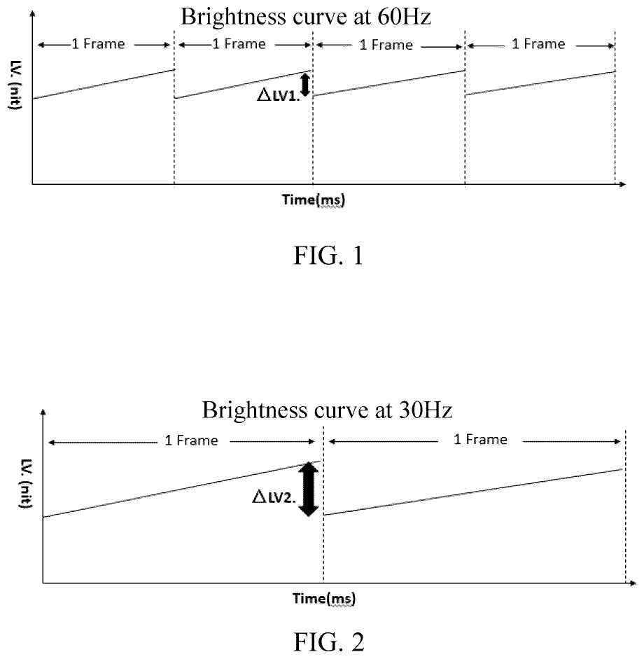

FIG. 1 is a brightness change curve when the refresh rate is 60 Hz, and FIG. 2 is a brightness change curve when the refresh rate is 30 Hz. ΔLV represents a difference of brightness change between two adjacent frames. It may be seen from FIG. 1 and FIG. 2 that when one frame of image is displayed, the difference of brightness change ΔLV1 when the refresh rate is 60 Hz is smaller than the difference of brightness change ΔLV2 when the refresh rate is 30 Hz. That is, the flicker phenomenon is more obvious at the low-frequency.

In order to solve the flicker problem of the display panel at the low refresh display in the related art, the present disclosure provides a pixel circuit, including: an initialization unit, a data writing unit, a driving transistor, a threshold compensation unit and a storage capacitor; where
the initialization unit is configured to transmit an initialization voltage to a first node in response to a first scan signal, to charge the storage capacitor; the first node is a connection node among a second terminal of the storage capacitor, a control terminal of the driving transistor, and the threshold compensation unit;
the threshold compensation unit and the data writing unit are configured to obtain a threshold voltage of the driving transistor and a data voltage transmitted by a data line in response to a second scan signal, and to write the threshold voltage and the data voltage to the first node; and
a coupling unit is electrically connected to at least one of the initialization unit, the threshold compensation unit or the driving transistor to reduce a potential fluctuation of the first node during a light emitting stage.

The potential fluctuation of the first node during the light emitting stage is reduced by the coupling unit, thereby reducing the brightness change, so that there is no obvious flickering on the screen when the screen is refreshed at a low rate, thus solving the flickering problem when the screen displays at a low refresh rate.

Accordingly, an embodiment of the present disclosure further provides a pixel circuit driving method for driving the pixel circuit as described above, and the method includes the following steps.

In an initialization stage, the first scan signal is at a working level, and a first initialization voltage initializes a potential of the first node.

In a data writing stage and a threshold compensation stage, the second scan signal is at a working level, and the data voltage and the threshold voltage of the driving transistor are transmitted to the first node and stored in the storage capacitor.

In a light emitting stage, a light emitting control signal is at a working level, and a driving current is provided to a light emitting device via the pixel circuit to control a light emitting display of the light emitting device.

The potential fluctuation of the first node during the light emitting stage is reduced by the coupling unit, thereby improving the obvious flickering problem of the screen at a low refresh rate.

An embodiment of the present disclosure further provides a display panel, which includes the pixel circuit as described above, so that the technical effects of the pixel circuit as described above can be achieved, which will not be repeated herein.

An embodiment of the present disclosure further provides a display apparatus, which includes the display panel as described above, so that the display apparatus can achieve all the technical effects of the display panel as described above, which will not be repeated herein.

Specifically, the present disclosure will be described in detail below with reference to specific embodiments.

### First Embodiment

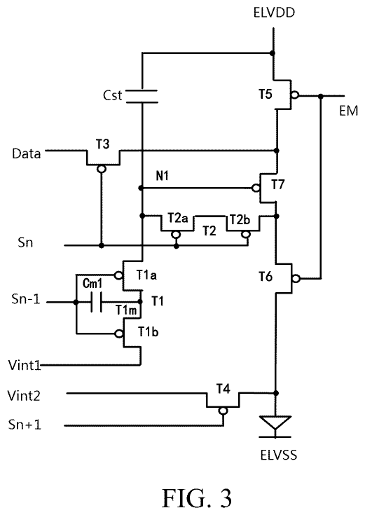

FIG. 3 shows a schematic diagram of a pixel circuit provided by the first embodiment. As shown in FIG. 3, the pixel circuit includes an initialization unit, a data writing unit, a driving transistor T7, a threshold compensation unit and a storage capacitor Cst. Specifically, the initialization unit includes a first transistor T1, a control terminal of the first transistor T1 is electrically connected to a first scan line Sn−1, a first terminal of the first transistor T1 is electrically connected to a first initialization signal line, and a second terminal of the first transistor is connected to a first node N1. The first transistor T1 is a dual-gate transistor, the coupling unit includes a first capacitor Cm1, and a first terminal of the first capacitor Cm1 is electrically connected to the first scan line Sn−1; a second terminal of the first capacitor Cm1 is electrically connected to an intermediate node T1m between the first terminal and the second terminal of the first transistor T1. The first initialization signal line provides a first initialization voltage Vint1, and the first scan signal line provides a first scan signal.

The threshold compensation unit includes a second transistor T2, a control terminal of the second transistor T2 is electrically connected to the second scan line Sn, a first terminal T2a of the second transistor T2 is electrically connected to the first node N1, and a second terminal T2b of the second transistor T2 is electrically connected to a second terminal of the driving transistor T7. The second scan line Sn provides a second scan signal. The data writing unit includes a third transistor T3, a control terminal of the third transistor T3 is electrically connected to the second scan line Sn, a first terminal of the third transistor T3 is electrically connected to the data line Data, and a second terminal of the third transistor T3 is electrically connected to a first terminal of the driving transistor T7. The data line DATA provides a data voltage Vdata.

The pixel circuit further includes a reset unit and a light emitting control unit, where the reset unit resets an anode potential of the OLED in response to a third scan signal; and the light emitting control unit is configured to output a driving current output by the driving transistor T7 to the OLED in response to a light emitting control signal to make the OLED emit light.

The reset unit includes a fourth transistor T4, a control terminal of the fourth transistor T4 is electrically connected to a third scan line Sn+1, a first terminal of the fourth transistor T4 is electrically connected to a second initialization signal line, and a second terminal of the fourth transistor T4 is electrically connected to the anode of the OLED. The third scan line Sn+1 provides a third scan signal. The pixel circuit further includes a second power supply ELVSS, and the light emitting control unit is placed between the first power supply ELVDD and the second power supply ELVSS. The first power supply ELVDD provides a positive power supply voltage, and the second power supply ELVSS provides a negative power supply voltage to drive the light emission of the OLED.

The light emitting control unit includes a fifth transistor T5 and a sixth transistor T6, where a control terminal of the fifth transistor T5 is electrically connected to a light emitting control line Em; a first terminal of the fifth transistor T5 is electrically connected to the first power source ELVDD, and a second terminal of the fifth transistor T5 is electrically connected to the first terminal of the driving transistor T7. The light emitting control line Em provides the light emitting control signal.

A control terminal of the sixth transistor T6 is electrically connected to the light emitting control line Em, a first terminal of the sixth transistor T6 is electrically connected to the second terminal of the driving transistor T7, and a second terminal of the sixth transistor T6 is electrically connected to the anode of the OLED.

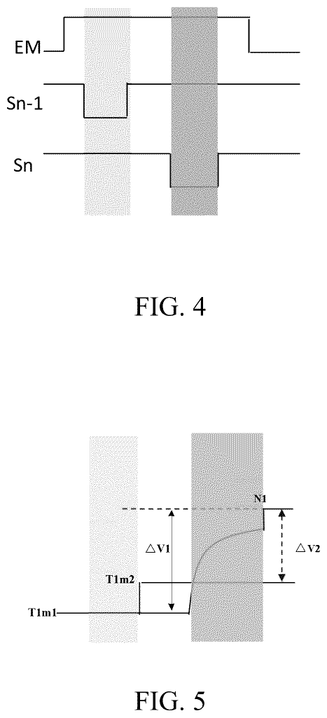

The embodiments of the present disclosure further provides a pixel circuit driving method for driving the pixel circuit as described above. With reference to the timing sequence shown in FIG. 4, it may be reached that the driving method includes the following steps.

In the initialization stage, the first scan signal is at a working level, and the first initialization voltage Vint1 initializes a potential of the first node N1.

In the data writing stage and the threshold compensation stage, the second scan signal is at a working level, and the data voltage Vdata and the threshold voltage Vth of the driving transistor T7 are transmitted to the first node N1 and stored in the storage capacitor Cst.

In the light emitting stage, the light emitting control signal is at a working level, and the pixel circuit provides a driving current to the OLED to control the OLED to emit light and display.

When the first scan signal changes from a low level to a high level, a potential of the first terminal of the first capacitor Cm1 is pulled up, and a potential of the intermediate node T1m is pulled up under the coupling effect of the first capacitor Cm1, so that the potential difference between the intermediate node T1m and the first node N1 can be reduced, thereby reducing the potential fluctuation of the first node N1 in the light emitting stage, thus reducing the low-frequency flicker of the OLED when emitting light, and improving the flickering problem of the screen at a low refresh frequency.

FIG. 5 is a diagram showing a potential change of the first node N1 corresponding to the driving timing sequence in FIG. 4. As shown in FIG. 5, when there is no first capacitor Cm1, after the end of the data writing stage and threshold compensation stage, the potential difference between the intermediate node T1m1 of the first transistor T1 and the first node N1 is ΔV1; and when the first capacitor Cm1 is added to the pixel circuit, the potential difference between intermediate node T1m2 of the first transistor T1 and the first node N1 is ΔV2, and A V2 is less than ΔV1. Since the potential difference between the first node N1 and the intermediate node T1m is reduced, the potential fluctuation of the first node N1 is reduced during the light emitting stage, thereby improving the fluctuation of the current and the brightness of light emission within a frame, so that the screen has no obvious flickering when displaying at a low refresh rate, which can improve the flickering problem of the OLED when displaying at low refresh rates.

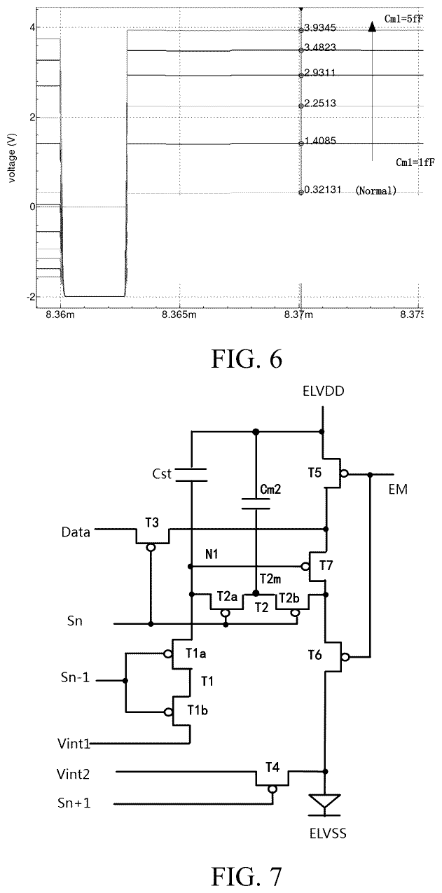

Furthermore, as shown in FIG. 6, simulation experiments are conducted to explore the potential increase of the node T1m under different capacitance values of Cm1. As shown in FIG. 6, when there is no first capacitor Cm1, the potential of the node T1m (normal point) is approximately 0.3V. From Cm1=1 fF to Cm1=5 fF, the potential of the intermediate node T1m also gradually increases. Therefore, as the capacitance value increases, the potential difference between T1m and the first node N1 can be further reduced, and the fluctuation of the first node N1 during the light emitting stage can be reduced, thereby improving the potential and brightness fluctuations when the screen emits light within one frame, and reducing the flickering problem when the screen emits light. Those skilled in the art may select the capacitance value of Cm1 according to actual display requirements.

### Second Embodiment

FIG. 7 shows a diagram of a pixel circuit of the second embodiment of the present disclosure. As shown in FIG. 3, the difference from the first embodiment is that the coupling unit is a second capacitor Cm2, the second transistor T2 is a dual-gate transistor, a first terminal of the second capacitor Cm2 is electrically connected to the first power source ELVDD, and a second terminal of the second capacitor Cm2 is electrically connected to an intermediate node T2m between a first terminal T2a and a second terminal T2b of the second transistor T2.

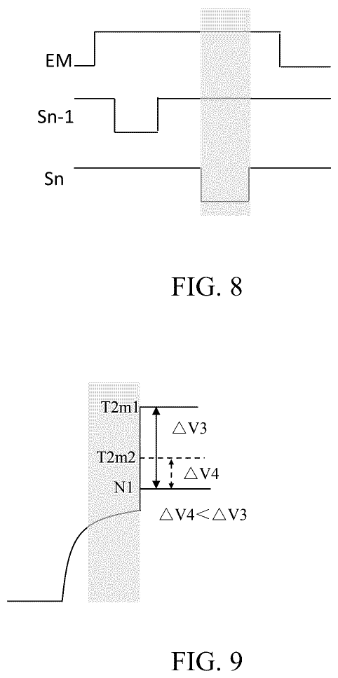

Accordingly, the second embodiment of the present disclosure further provides a driving method for a pixel circuit. As shown in FIG. 8 and FIG. 9, the difference from the driving method in the first embodiment is that the voltage difference between the first node N1 and the intermediate node T2m is controlled by the second capacitor Cm2, so that the potential fluctuation and brightness fluctuation of the first node N1 in the light emitting stage are reduced, thereby improving the flickering problem when the screen is refreshed at a low rate.

When the second scan signal changes from a low level to a high level, the potentials of both the first node N1 and the intermediate node T2m will be pulled up due to the capacitive coupling effect. Since the first node N1 is connected to the storage capacitor Cst with a relatively large capacitance value, and the node T2m has only a small amount of parasitic capacitance, the potential raised at the node T2m is relatively large, while the potential raised at the node N1 is relatively small (negligible herein). As shown in FIG. 9, in this case, the potential difference between the first node N1 and the intermediate node T2m1 after being pulled up is ΔV3, and ΔV3 is relatively large. That is, there is a relatively large Vds in T2a, and leakage will be generated between the nodes T2m and N1, which will cause a large fluctuation at the node N1 during the light emitting stage, resulting in obvious flickering of the screen when the screen is refreshed at a low rate.

Under the capacitive coupling effect, the potential change at T2m is as the following equation:

$$Δ {V}_{T 2 m} = \vert {V}_{G H} - {V}_{G L} \vert \frac{{C}_{{S}_{n} - {T}_{2 m}}}{{C}_{{S}_{n} - {T}_{2 m}} + {C}_{{T}_{2 m}}}$$

where ΔV_{T2m} is the potential raised at T2m; V_{GH} is the high level signal voltage of the second scan line Sn, VGL is the low level signal voltage of the second scan line Sn, C_{S}_{ₙ}_{-T}_{₂}ₘ is the parasitic capacitance between the first scan signal line and the node T2m, and C_{T}_{₂ₘ} is the coupling capacitance at the node T2m.

When the coupling unit C2m is added, C_{T}_{₂ₘ} is increased, which reduces the potential increase at the node T2m caused by the capacitive coupling effect during the process of the second scan line Sn changing from low to high, thereby reducing the potential difference with the node N1. As shown in FIG. 9, when the coupling unit C2m is added, after completing the data writing and threshold compensation, the potential difference between the first node N1 and the intermediate node T2m is ΔV4, and ΔV4 is less than ΔV3, and the potential difference between T2m and N1 is reduced. Therefore, in the light emitting stage, the potential fluctuation of the node N1 can be reduced through the second capacitor C2m, thereby reducing the occurrence of low-frequency flicker of the OLED.

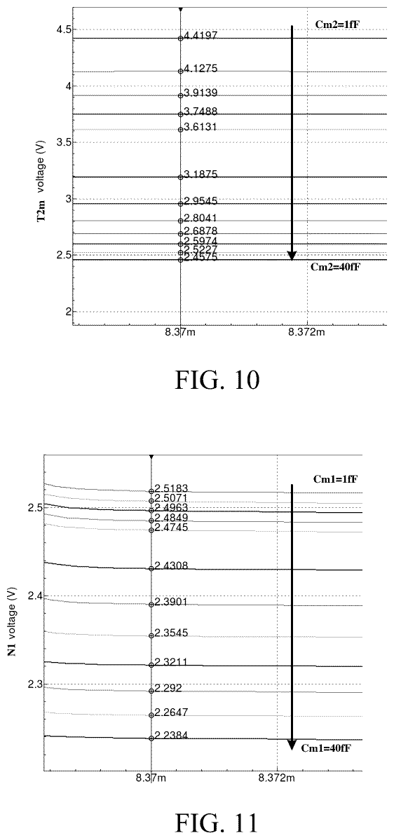

Furthermore, simulation experiments are conducted to explore the potential increase of nodes N1 and T2m under different capacitance values of Cm2. FIGS. 10 and 11 respectively show the diagrams of potential changes of nodes N1 and T2m when the capacity of the second capacitor Cm2 changes from 1 fF to 40 fF. It may be seen from FIG. 10 and FIG. 11 that as the capacity of Cm2 increases, the potentials of the first node N1 and the intermediate node T2m gradually decrease.

When Cm2=1 fF, the potential difference between the two nodes is V3=4.4197−2.5183=1.9014V.

When Cm2=40 fF, the potential difference between the two nodes is V4=2.4575−2.2384=0.2191V.

It may be concluded that as the capacitance value of the second capacitor Cm2 increases, the voltage difference between the nodes T2m and N1 is reduced, that is, Vds of T2a decreases and the current leakage decreases. Therefore, during the light emitting stage, the potential fluctuation of the first node N1 can be improved, thereby reducing the flickering problem that occurs on the screen at a low refresh rate.

### Third Embodiment

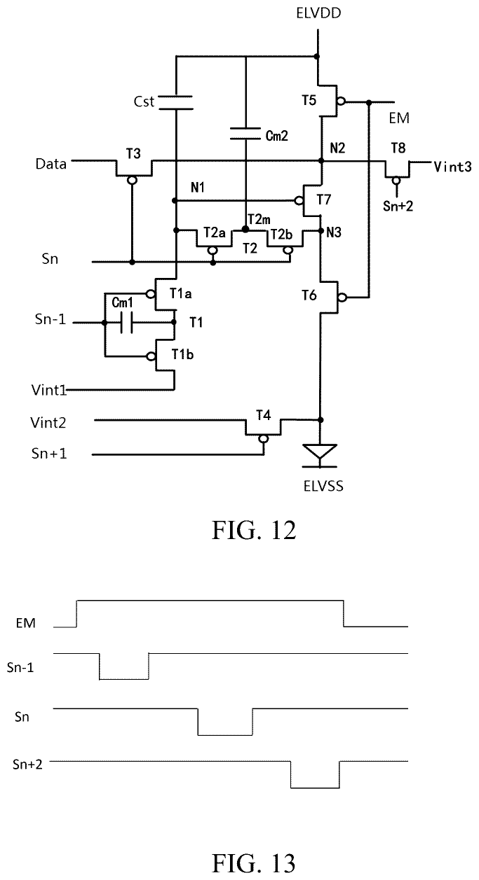

As shown in FIG. 12, the present disclosure further provides a pixel circuit of the third embodiment. In addition to adding the first capacitor Cm1 and the second capacitor Cm2, the difference from the first embodiment and the second embodiment is that, in the third embodiment, an eighth transistor T8 is added at a second node N2, a first terminal of the eighth transistor T8 is electrically connected to a third initialization signal line, a second terminal thereof is electrically connected to the second node N2, and the control terminal thereof is electrically connected to a fourth scan line Sn+2.

As shown in FIG. 13, after the data writing and threshold compensation are completed, the first node N1 turns on the driving transistor T7, a fourth scan signal provided by the fourth scan line Sn+2 is converted from a high level to a low level, and a third initialization voltage Vint3 is transmitted to a third node N3 sequentially through the eighth transistor T8 and the driving transistor T7, where Vint3 is a positive potential. Under the effect of Vint3, the potential of the node N3 is pulled up, the change of the potential of T2m caused by the leakage of T2b is weakened, and the potential difference between the nodes T2m and the N1 is further reduced, thereby improving the fluctuation of the potential of the node N1 during the light emitting stage and reducing the flickering of the OLED when it emits light.

In the third embodiment, T1m and T2m are not connected together, so there will be no leakage from T1m and T2m to the first node N1 at the same time. The leakage direction of T1m is from the first node N1 to T1m, while the leakage direction of T2m is from T2m to the first node N1, and the different leakage directions have a certain mutual counteracting effect to further reduce the potential fluctuation of the first node N1 during one frame.

### Fourth Embodiment

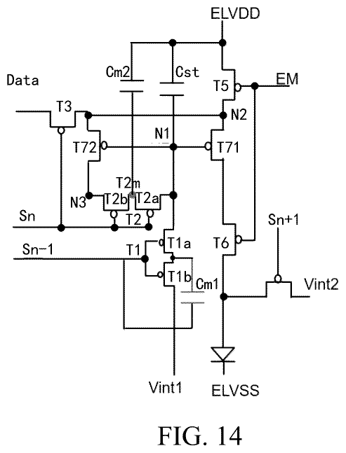

As shown in FIG. 14, an embodiment of the present disclosure further provides a pixel circuit of the fourth embodiment, which is different from the pixel circuits in the first to third embodiments in that the driving transistor in the pixel circuit in the fourth embodiment includes a first sub-driving transistor T71 and a second sub-driving transistor T72, the first sub-driving transistor 71 and the second sub-driving transistor 72 may be transistors that are mirror-symmetric on the array substrate, and the two transistors have exactly the same size and the same threshold voltage.

Control terminals of the first sub-driving transistor T71 and the second sub-driving transistor T72 are electrically connected to the first node N1, a first terminal of the second sub-driving transistor T72 is electrically connected to the second terminal of the third transistor T3, a second terminal of the second sub-driving transistor T72 is electrically connected to the third node N3 and the first terminal of the compensation transistor T2, and the second terminal of the second transistor T2 is electrically connected to the first node N1; a first terminal of the first sub-driving transistor T71 is electrically connected to the second node N2, and a second terminal of the second sub-driving transistor T72 is electrically connected to the first terminal of the sixth transistor T6.

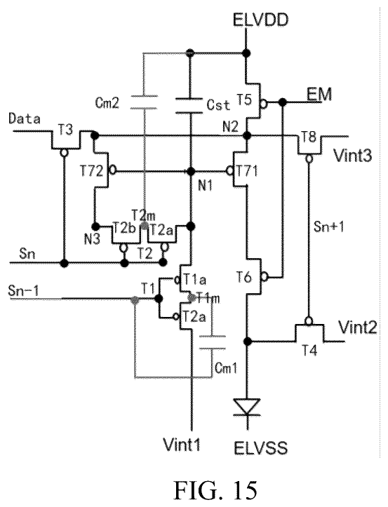

The driving method of the pixel circuit in the fourth embodiment may refer to the driving timing sequence shown in FIG. 15. In one frame display cycle, the driving method of the pixel circuit includes the following steps.

In the initialization stage, the first scan signal is at a working level (low level), and the first initialization voltage Vint1 initializes the potential of the first node N1 through the first transistor T1.

In the data writing stage and the threshold compensation stage, the second scan signal is at a working level (low level), and the data voltage Vdata and the threshold voltage Vth of the second sub-driving transistor T72 are transmitted to the first node N1 through the third transistor T3 and the second transistor T2, and stored in the storage capacitor Cst.

In the light emitting stage, the light emitting control signal is at a working level (low level), the fifth transistor T5 and the sixth transistor T6 are conducted, and the driving current of the first sub-driving transistor T71 is transmitted to both terminals of the OLED to drive the OLED to emit light and display.

When the first scan signal changes from a low level to a high level, the potential of the first terminal of the first capacitor Cm1 is pulled up, and the potential of the intermediate node T1m is pulled up under the coupling effect of the first capacitor Cm1, so that the potential difference between the intermediate node T1m and the first node N1 is reduced, thereby reducing the potential fluctuation of the first node N1 in the light emitting stage, reducing the low-frequency flickering of the OLED when emitting light, and improving the flickering problem of the screen at a low refresh frequency.

When the second scan signal changes from a low level to a high level, the potential of the intermediate node T2m will be pulled up due to the coupling of the second capacitor Cm2, so that the potential difference with the point N1 may be reduced. Therefore, in the light emitting stage, the potential fluctuation of the node N1 can be reduced through the second capacitor C2m, thereby reducing the occurrence of low-frequency flickering of the OLED.

### Fifth Embodiment

As shown in FIG. 15, the embodiment of the present disclosure further provides a pixel circuit of the fifth embodiment, which is different from the fourth embodiment in that an eighth transistor T8 is added to the pixel circuit of the fifth embodiment, and a control terminal of the eighth transistor T8 is electrically connected to the third scan line Sn+1. When the third scan signal is at a working level, the third initialization voltage Vint3 is transmitted to the third node N3 through the eighth transistor T8 and the second sub-driving transistor T72, where Vint3 is a positive potential. Under the effect of Vint3, the potential of the node N3 is pulled up, and the change of the potential of T2m caused by the leakage of T2b is weakened, so that the potential difference between T2m and N1 is further reduced, thereby improving the fluctuation of the potential of the node N1 during the light emitting stage, and reducing the flickering of the OLED when it emits light.

Accordingly, the present disclosure further provides a display panel, which includes any one of the pixel circuits described above, and the display panel can achieve all the technical effects of the above-mentioned pixel circuits. The specific related technical effects are referred to the technical effects achieved by the pixel circuits in each embodiment, which will not be repeated herein.

Accordingly, a display apparatus provided by an embodiment of the present disclosure includes the display panel as described above, and the display apparatus can achieve all the technical effects of the above-mentioned display panel, which will not be repeated herein. Specifically, the display apparatus may be any apparatus that displays images whether in motion (e.g., video) or stationary (e.g., still images) and whether text or images. More specifically, it is expected that the embodiments can be implemented in a variety of electronic apparatuses or in association with a variety of electronic apparatuses. The various electronic apparatuses are, for example (but not limited to), mobile phones, wireless apparatuses, personal data assistants (PDAs), handheld or portable computers, GPS receivers/navigators, cameras, MP4 video players, video cameras, game consoles, watches, clocks, calculators, TV monitors, flat panel displays, computer monitors, automotive displays (e.g., odometer displays, etc.), navigators, cockpit controllers and/or displays, displays for camera views (e.g., displays for rear-view cameras in vehicles), electronic photos, electronic billboards or signs, projectors, architectural structures, packaging and aesthetic structures, etc.

The pixel circuit and driving method thereof, display panel and display apparatus provided by the present disclosure have the following advantages.

The present disclosure reduces the potential fluctuation of the first node during the light emitting stage through a coupling unit, so that the brightness fluctuation of the light emitting device is reduced during the light emitting stage, thereby reducing the occurrence of flickering problem when the screen is refreshed at a low rate.

The above content is a further detailed description of the present disclosure with reference to specific embodiments, and it cannot be considered that the specific implementation of the present disclosure is limited to these descriptions. For those of ordinary skill in the art, without departing from the concept of the present disclosure, some simple deductions or substitutions may be made, all of which should be regarded as falling within the scope of protection of the present disclosure.

1. A pixel circuit, comprising: an initialization unit, a data writing unit, a driving transistor, a threshold compensation unit and a storage capacitor; wherein,
the initialization unit is configured to transmit an initialization voltage to a first node in response to a first scan signal, to charge the storage capacitor; the first node is a connection node among a second terminal of the storage capacitor, a control terminal of the driving transistor, and the threshold compensation unit;
the threshold compensation unit and the data writing unit are configured to obtain a threshold voltage of the driving transistor and a data voltage transmitted by a data line in response to a second scan signal, and to write the threshold voltage and the data voltage to the first node; and
a coupling unit is electrically connected to at least one of the initialization unit, the threshold compensation unit or the driving transistor, to reduce a potential fluctuation of the first node during a light emitting stage.

2. The pixel circuit according to claim 1, wherein the initialization unit comprises a first transistor, a control terminal of the first transistor is electrically connected to a first scan line, a first terminal of the first transistor is electrically connected to a first initialization signal line, and a second terminal of the first transistor is electrically connected to the first node.

3. The pixel circuit according to claim 2, wherein the first transistor is a dual-gate transistor, the coupling unit comprises a first capacitor, a first terminal of the first capacitor is electrically connected to the first scan line, and a second terminal of the first capacitor is electrically connected to an intermediate node between the first terminal and the second terminal of the first transistor.

4. The pixel circuit according to claim 3, wherein the threshold compensation unit comprises a second transistor, a control terminal of the second transistor is electrically connected to a second scan line, a first terminal of the second transistor is electrically connected to the first node, and a second terminal of the second transistor is electrically connected to the driving transistor.

5. The pixel circuit according to claim 4, wherein the second transistor is a dual-gate transistor, the pixel circuit further comprises a first power supply, the coupling unit comprises a second capacitor, a first terminal of the second capacitor is electrically connected to the first power supply, and a second terminal of the second capacitor is electrically connected to an intermediate node between the first terminal and the second terminal of the second transistor.

6. The pixel circuit according to claim 4, wherein the data writing unit comprises a third transistor, a control terminal of the third transistor is electrically connected to the second scan line, a first terminal of the third transistor is electrically connected to the data line, and a second terminal of the third transistor is electrically connected to the driving transistor.

7. The pixel circuit according to claim 6, further comprising a reset unit and a light emitting control unit, wherein the reset unit is configured to reset a potential of a first terminal of a light emitting device in response to a third scan signal; and the light emitting control unit is configured to output a driving current output by the driving transistor to the light emitting device in response to a light emitting control signal, so that the light emitting device emits light.

8. The pixel circuit according to claim 7, wherein the reset unit comprises a fourth transistor, a control terminal of the fourth transistor is electrically connected to a third scan line, a first terminal of the fourth transistor is electrically connected to a second initialization signal line, and a second terminal of the fourth transistor is electrically connected to the first terminal of the light emitting device.

9. The pixel circuit according to claim 8, further comprising a second power supply, wherein the light emitting control unit is provided between a first power supply and the second power supply to drive the light emitting device to emit light.

10. The pixel circuit according to claim 9, wherein the light emitting control unit comprises a fifth transistor and a sixth transistor, a control terminal of the fifth transistor is electrically connected to a light emitting control line; a first terminal of the fifth transistor is electrically connected to the first power supply, and a second terminal of the fifth transistor is electrically connected to the driving transistor; and wherein a control terminal of the sixth transistor is electrically connected to the light emitting control line, a first terminal of the sixth transistor is electrically connected to the driving transistor, and a second terminal of the sixth transistor is electrically connected to the first terminal of the light emitting device.

11. The pixel circuit according to claim 10, wherein the coupling unit further comprises an eighth transistor, a control terminal of the eighth transistor is electrically connected to the third scan line or a fourth scan line, a first terminal of the eighth transistor is electrically connected to a third initialization signal line, and a second terminal of the eighth transistor is electrically connected to the driving transistor.

12. The pixel circuit according to claim 11, wherein a first terminal of the driving transistor is electrically connected to the second terminal of the fifth transistor, and a second terminal of the driving transistor is electrically connected to the first terminal of the sixth transistor and the second terminal of the second transistor.

13. The pixel circuit according to claim 11, wherein the driving transistor comprises a first sub-driving transistor and a second sub-driving transistor, a control terminal of the first sub-driving transistor and a control terminal of the second sub-driving transistor are electrically connected to the first node, a first terminal of the first sub-driving transistor is electrically connected to the second terminal of the fifth transistor, and a second terminal of the first sub-driving transistor is electrically connected to the first terminal of the sixth transistor;
a first terminal of the second sub-driving transistor is electrically connected to the second terminal of the third transistor and the second terminal of the fifth transistor, and a second terminal of the second sub-driving transistor is electrically connected to the first terminal of the second transistor.

14. A method for driving a pixel circuit, used for driving the pixel circuit according to claim 1, wherein the method comprises following steps:
in an initialization stage, the first scan signal being at a working level, and a first initialization voltage initializing a potential of the first node;
in a data writing stage and a threshold compensation stage, the second scan signal being at a working level, and the data voltage and the threshold voltage of the driving transistor being transmitted to the first node and stored in the storage capacitor;
in a light emitting stage, a light emitting control signal being at a working level, and a driving current being provided to a light emitting device via the pixel circuit to control a light emitting display of the light emitting device;
wherein the potential fluctuation of the first node during the light emitting stage is reduced by the coupling unit.

15. A display panel, comprising a pixel circuit, wherein the pixel circuit comprises: an initialization unit, a data writing unit, a driving transistor, a threshold compensation unit and a storage capacitor; wherein,
the initialization unit is configured to transmit an initialization voltage to a first node in response to a first scan signal, to charge the storage capacitor; the first node is a connection node among a second terminal of the storage capacitor, a control terminal of the driving transistor, and the threshold compensation unit;
the threshold compensation unit and the data writing unit are configured to obtain a threshold voltage of the driving transistor and a data voltage transmitted by a data line in response to a second scan signal, and to write the threshold voltage and the data voltage to the first node; and
a coupling unit is electrically connected to at least one of the initialization unit, the threshold compensation unit or the driving transistor, to reduce a potential fluctuation of the first node during a light emitting stage.

16. A display apparatus, comprising the display panel according to claim 15.

17. The display panel according to claim 15, wherein the initialization unit comprises a first transistor, a control terminal of the first transistor is electrically connected to a first scan line, a first terminal of the first transistor is electrically connected to a first initialization signal line, and a second terminal of the first transistor is electrically connected to the first node.

18. The display panel according to claim 17, wherein the first transistor is a dual-gate transistor, the coupling unit comprises a first capacitor, a first terminal of the first capacitor is electrically connected to the first scan line, and a second terminal of the first capacitor is electrically connected to an intermediate node between the first terminal and the second terminal of the first transistor.

19. The display panel according to claim 18, wherein the threshold compensation unit comprises a second transistor, a control terminal of the second transistor is electrically connected to a second scan line, a first terminal of the second transistor is electrically connected to the first node, and a second terminal of the second transistor is electrically connected to the driving transistor.

20. The display panel according to claim 19, wherein the second transistor is a dual-gate transistor, the pixel circuit further comprises a first power supply, the coupling unit comprises a second capacitor, a first terminal of the second capacitor is electrically connected to the first power supply, and a second terminal of the second capacitor is electrically connected to an intermediate node between the first terminal and the second terminal of the second transistor.
